(19) United States
(12) Patent Application Publication
(10) Pub. No.: US 2023/0050324 A1
(43) Pub. Date: Feb. 16, 2023

(54) EMERGENCY LIGHTING CIRCUIT, CONTROL METHOD THEREOF AND EMERGENCY LIGHTING SYSTEM

(71) Applicant: Shenzhen Yihui Lighting Co., Ltd, Shenzhen (CN)

(72) Inventors: Jianwei WANG, Shenzhen (CN); Lin YANG, Shenzhen (CN)

(21) Appl. No.: 17/578,116

(22) Filed: Jan. 18, 2022

(30) Foreign Application Priority Data
Aug. 16, 2021 (CN) 202110937171.7

(51) Int. Cl. H02J 9/06; H02J 7/04; H05B 47/10

(52) U.S. Cl. CPC H02J 9/065; H02J 7/04; H05B 47/10

(57) ABSTRACT

The present disclosure relates to an emergency lighting circuit, a control method thereof and an emergency lighting system. Normal lighting is monitored by detecting whether a charging management apparatus in the emergency lighting circuit has electric energy input. When the charging management apparatus has no electric energy input, emergency lighting may be started, and power transmitted to load lighting equipment is switched to an emergency battery apparatus through a power supply switching apparatus, which is processed by a boost inverter to provide appropriate electric energy for the load lighting equipment. A power detection apparatus detects an input-terminal power signal of the boost inverter, and regulates power of the load lighting equipment based on the input-terminal power signal. Operating power of the load lighting equipment is regulated based on the input-terminal power signal of the boost inverter. An input-terminal voltage of the boost inverter is a DC low voltage and easy to detect. Moreover, in the solution, high voltage and current are not required to be isolated for power detection, which effectively reduces detection costs and is highly reliable in power detection.

### CROSS-REFERENCE TO RELATED APPLICATIONS

This application claims benefit of Chinese Application No. 202110937171.7, filed Aug. 16, 2021, entitled EMERGENCY LIGHTING CIRCUIT, CONTROL METHOD THEREOF AND EMERGENCY LIGHTING SYSTEM, the specification of which is incorporated by reference herein in its entirety.

### TECHNICAL FIELD

The present disclosure relates to the field of lighting technologies, and in particular, to an emergency lighting circuit, a control method thereof and an emergency lighting system.

### BACKGROUND

Lighting started due to failure of a power source for normal lighting is referred to as emergency lighting. The emergency lighting is an important safety facility in modern public and industrial buildings, which is closely related to personal safety and building safety. When a fire or another disaster occurs in a building and a power failure occurs, the emergency lighting has important influence on personnel evacuation, fire rescue work, continuation of important production and work or necessary operation and disposal.

There are many schemes for emergency lighting at present. When the emergency lighting is started, a voltage and a current at an output terminal of a boost inverter module are detected mostly, so as to regulate power to enable emergency lighting equipment to operate at required power. However, during actual operation, the boost inverter module outputs an unsafe high voltage, which is not easy to detect. A conventional emergency lighting system has a disadvantage of poor reliability in power detection.

### SUMMARY

In view of the above, there is a need to provide an emergency lighting circuit, a control method thereof and an emergency lighting system with respect to the problem that the conventional emergency lighting system has poor reliability in power detection.

A control method for an emergency lighting circuit includes: detecting, in real time, whether a charging management apparatus of the emergency lighting circuit has electric energy input; controlling, when the charging management apparatus has no electric energy input a power supply switching apparatus of the emergency lighting circuit to switch to powering load lighting equipment through an emergency battery apparatus of the emergency lighting circuit; and acquiring an input-terminal power signal of a boost inverter of the emergency lighting circuit, and regulating power of the load lighting equipment based on the input-terminal power signal; the input-terminal power signal being detected and sent through a power detection apparatus of the emergency lighting circuit, the charging management apparatus and the power supply switching apparatus being connected to an external power source, the charging management apparatus being connected to the emergency battery apparatus, the emergency battery apparatus being connected to an input terminal of the boost inverter and the power detection apparatus, an output terminal of the boost inverter being connected to the power supply switching apparatus, and the power supply switching apparatus being connected to the load lighting equipment.

In one embodiment, subsequent to the step of detecting, in real time, whether a charging management apparatus of the emergency lighting circuit has electric energy input, the method further includes: controlling, when the charging management apparatus has electric energy input, the power supply switching apparatus of the emergency lighting circuit to switch to powering the load lighting equipment through the external power source.

In one embodiment, when the charging management apparatus has electric energy input, the method further includes: receiving an external dimming signal inputted by a user, and regulating the power of the load lighting equipment based on the external dimming signal.

In one embodiment, the step of acquiring an input-terminal power signal of a boost inverter of the emergency lighting circuit includes: collecting an input-terminal voltage signal and an input-terminal current signal of the boost inverter of the emergency lighting circuit in real time; and obtaining the input-terminal power signal based on the input-terminal voltage signal and the input-terminal current signal.

In one embodiment, subsequent to the step of controlling, when the charging management apparatus has no electric energy input a power supply switching apparatus of the emergency lighting circuit to switch to powering load lighting equipment through an emergency battery apparatus of the emergency lighting circuit and prior to the step of acquiring an input-terminal power signal of a boost inverter of the emergency lighting circuit, and regulating power of the load lighting equipment based on the input-terminal power signal, the method further includes: controlling a dimming switching apparatus of the emergency lighting circuit to switch to an emergency dimming operation state.

An emergency lighting circuit includes: a charging management apparatus, an emergency battery apparatus, a boost inverter, a power detection apparatus, a power supply switching apparatus and an emergency control apparatus, the charging management apparatus being connected to an external power source, the emergency battery apparatus and the emergency control apparatus being connected to the charging management apparatus, the emergency battery apparatus being connected to an input terminal of the boost inverter and the power detection apparatus, the power detection apparatus being connected to the emergency control apparatus, a control terminal of the boost inverter being connected to the emergency control apparatus, an output terminal of the boost inverter being connected to the power supply switching apparatus, the power supply switching apparatus being connected to the external power source, the emergency control apparatus being connected to the power supply switching apparatus, the power supply switching apparatus being connected to load lighting equipment, and the emergency control apparatus being connected to the load lighting equipment; the emergency control apparatus being configured to perform emergency lighting control according to the control method described above.

In one embodiment, the emergency lighting circuit further includes a dimming switching apparatus, the emergency control apparatus is connected to the load lighting equipment through the dimming switching apparatus, and the dimming switching apparatus is connected to an external dimming apparatus.

In one embodiment, the emergency control apparatus includes an emergency dimmer and a processor, the processor is connected to the emergency dimmer, the emergency dimmer and the processor are connected to the dimming switching apparatus, and the charging management apparatus, the power supply switching apparatus and the input terminal and the control terminal of the boost inverter are connected to the processor.

In one embodiment, the emergency battery apparatus includes a battery and a sampling resistor, a first terminal of the battery is connected to the charging management apparatus and the boost inverter, a second terminal of the battery is connected to a first terminal of the sampling resistor, the charging management apparatus and the power detection apparatus, and a second terminal of the sampling resistor is connected to the boost inverter.

An emergency lighting system includes load lighting equipment and the emergency lighting circuit described above, the emergency control apparatus being configured to perform emergency lighting control according to the control method described above.

According to the emergency lighting circuit, the control method thereof and the emergency lighting system, normal lighting is monitored by detecting whether the charging management apparatus in the emergency lighting circuit has electric energy input, and when the charging management apparatus has no electric energy input, it indicates failure of power supply of the external power source. In this case, emergency lighting may be started, and a power source transmitted to the load lighting equipment is switched to the emergency battery apparatus through the power supply switching apparatus, which is processed by the boost inverter to provide appropriate electric energy for the load lighting equipment. At the same time, the power detection apparatus detects an input-terminal power signal of the boost inverter, and regulates power of the load lighting equipment based on the input-terminal power signal, to realize an emergency lighting operation. In the above solutions, operating power of the load lighting equipment is regulated based on the input-terminal power signal of the boost inverter. An input-terminal voltage of the boost inverter is a DC low voltage and easy to detect. Moreover, in the solutions, high voltage and current are not required to be isolated for power detection, which effectively reduces detection costs and is highly reliable in power detection.

### BRIEF DESCRIPTION OF THE DRAWINGS

In order to more clearly illustrate the technical solutions in embodiments of the present disclosure or the conventional art, the accompanying drawings used in the description of the embodiments or the conventional art will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a schematic flowchart of a control method for an emergency lighting circuit according to an embodiment;

FIG. 2 is a schematic structural diagram of an emergency lighting circuit according to an embodiment;

FIG. 3 is a schematic flowchart of a control method for an emergency lighting circuit according to another embodiment;

FIG. 4 is a schematic flowchart of a control method for an emergency lighting circuit according to yet another embodiment;

FIG. 5 is a schematic flowchart of a control method for an emergency lighting circuit according to still another embodiment;

FIG. 6 is a schematic structural diagram of an emergency lighting circuit according to another embodiment; and

FIG. 7 is a schematic structural diagram of an emergency lighting circuit according to yet another embodiment.

### DETAILED DESCRIPTION

To facilitate understanding of the present disclosure, a more comprehensive description of the present disclosure will be given below with reference to the relevant accompanying drawings. Preferred embodiments of the present disclosure are given in the drawings. However, the present disclosure may be implemented in many different forms and is not limited to the embodiments described herein. Rather, these embodiments are provided to make the contents disclosed in the present disclosure more fully understood.

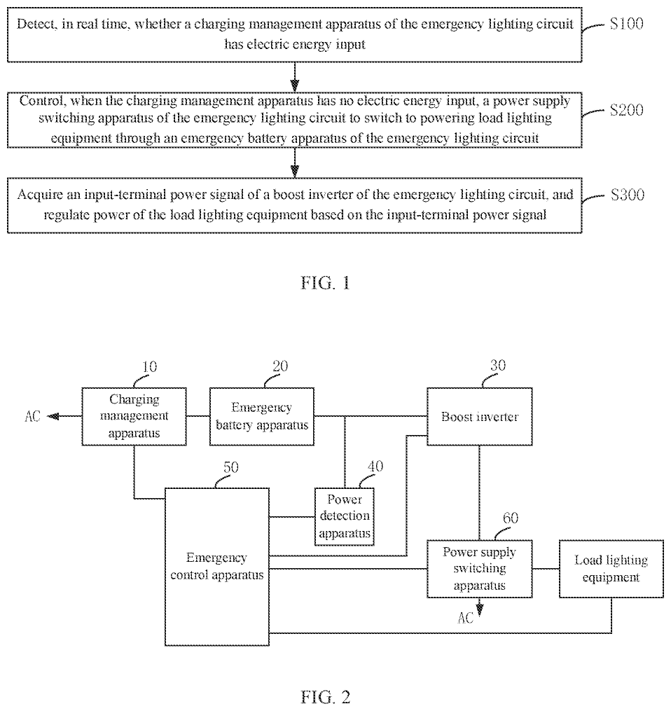

Referring to FIG. 1, a control method for an emergency lighting circuit includes step S100, step S200 and step S300.

In step S100, it is detected, in real time, whether a charging management apparatus of the emergency lighting circuit has electric energy input.

Specifically, the charging management apparatus is an apparatus that uses an external power source to charge and manage an energy storage device. The external power source is generally an AC power source, and the charging management apparatus generally includes an AC-DC converter (such as a rectifier device), a current-limiting device, a voltage-limiting device, and the like. An AC power source externally inputted may be converted, through the charging management apparatus, into a DC power source with a voltage or current required by the energy storage device, so as to charge the energy storage device and ensure charging safety. In the solution of the present embodiment, the emergency lighting circuit is provided with an emergency control apparatus. The emergency control apparatus is connected to the charging management apparatus, and can collect, in real time, an AC voltage signal inputted to the charging management apparatus or a DC voltage signal into which the AC voltage signal is converted by the charging management apparatus, so as to detect whether an external AC power source is normally connected to supply power to the load lighting equipment.

It should be noted that, a specific structure of the charging management apparatus is not unique, provided that it has an AC-DC conversion function as well as current-limiting charging and voltage-limiting charging functions for the energy storage device. For example, in a more detailed embodiment, the charging management apparatus is connected to the external AC power source, and a fuse is provided at a junction with a live wire of the external AC power source. Then, a rectifier device is connected behind the fuse for AC/DC conversion. Finally, voltage limiting and current limiting charging for a back-end emergency battery apparatus are realized by performing operations such as voltage transformation and current limiting on a DC power source outputted by the rectifier device.

In step S200, when the charging management apparatus has no electric energy input, a power supply switching apparatus of the emergency lighting circuit is controlled to switch to powering load lighting equipment through an emergency battery apparatus of the emergency lighting circuit.

Specifically, the charging management apparatus having no electric energy input may mean that an input terminal of the charging management apparatus has no AC power input or a DC output terminal of the charging management apparatus has no DC output. In either case, the external power source connected to the charging management apparatus fails. The external power source is further configured to supply power to the load lighting equipment. When it is detected that the charging management apparatus has no electric energy input, it indicates that the external power source cannot normally supply power to the load lighting equipment. In this case, the emergency control apparatus may switch a power supply line through the power supply switching apparatus, which switches a line originally powering the load lighting equipment directly from the external power source to powering the load lighting equipment through electric energy stored in the emergency battery apparatus.

It should be noted that a specific type of the power supply switching apparatus is not unique. In one embodiment, the power supply switching apparatus is specifically a switch apparatus. In case of power supply switching, a power supply line switching operation can be realized only when the emergency control apparatus controls a switch device corresponding to the emergency battery apparatus to be turned on or controls a switch device corresponding to the external power source to be turned on. A specific type of the switch device is not unique, which may be a triode, a relay, or the like, provided that a switch function can be realized under the control of the emergency control apparatus.

In step S300, an input-terminal power signal of the boost inverter of the emergency lighting circuit is acquired, and power of the load lighting equipment is regulated based on the input-terminal power signal.

Specifically, the input-terminal power signal is detected and sent through the power detection apparatus of the emergency lighting circuit. Referring to FIG. 2, a charging management apparatus 10 and a power supply switching apparatus 60 are connected to an external power source, the charging management apparatus 10 is connected to an emergency battery apparatus 20, the emergency battery apparatus 20 is connected to an input terminal of a boost inverter 30 and a power detection apparatus 40, an output terminal of the boost inverter 30 is connected to the power supply switching apparatus 60, and the power supply switching apparatus 60 is connected to load lighting equipment.

In the solution of the present embodiment, the charging management apparatus 10, the power supply switching apparatus 60, the power detection apparatus 40 and the boost inverter 30 are all connected to an emergency control apparatus 50. After an emergency lighting state is entered, the electric energy stored in the emergency charging apparatus may be released, and originally stored low-voltage DC electricity is converted into electric energy with a higher voltage through boost and inversion functions of the boost inverter 30, so as to realize an operation of powering the load lighting equipment. At the same time, a power detection apparatus 40 is further arranged between the input terminal of the boost inverter 30 and output of the emergency battery apparatus 20. When emergency lighting is started, the power apparatus can detect an input-terminal power signal at the input terminal of the boost inverter 30 in real time, and then output a corresponding dimming signal to the load lighting equipment in combination with the input-terminal power signal, so as to regulate the load lighting equipment to corresponding power for operation.

Similarly, a specific structure of the boost inverter 30 is not unique. In one embodiment, the boost inverter 30 may include two parts, i.e., an inverter and a boost transformer. The inverter is connected to the emergency battery apparatus 20. The boost transformer is connected to the inverter and the power supply switching apparatus 60. Therefore, after DC electricity outputted by the corresponding emergency battery apparatus 20 is inverted and boosted, high-voltage electric energy is provided for the load lighting equipment.

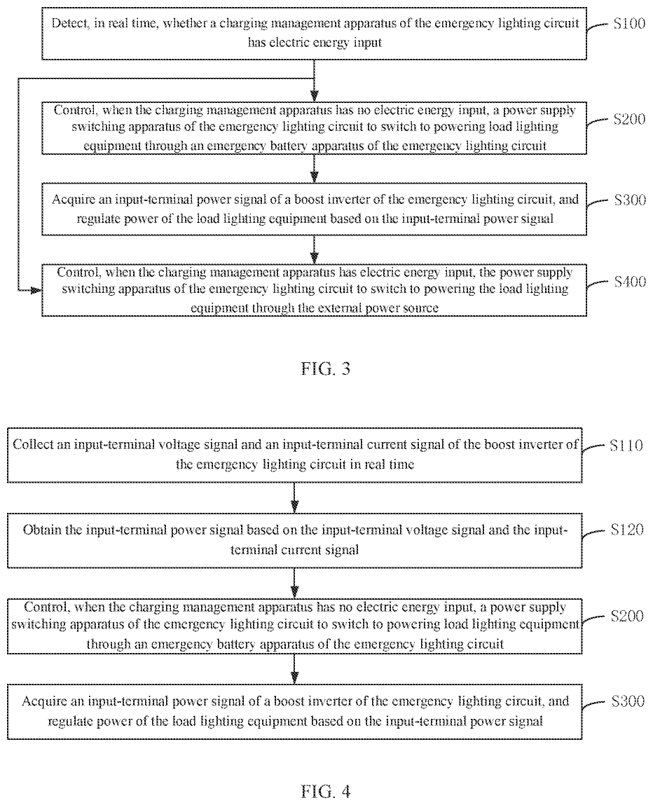

Referring to FIG. 3, in one embodiment, subsequent to step S100, the method further includes step S400.

In step S400, when the charging management apparatus has electric energy input, the power supply switching apparatus of the emergency lighting circuit is controlled to switch to powering the load lighting equipment through the external power source.

Specifically, during the operation of the emergency lighting circuit, a situation may also occur that the charging management apparatus 10 has electric energy input when the emergency control apparatus 50 detects whether the charging management apparatus 10 has electric energy input. In this case, the external power source is effective, and the external power source can supply power to the load lighting equipment. Thus, in this case, the emergency control apparatus 50 switches the power supply switching apparatus 60 to a line that powers the load lighting equipment through the external power source, so as to realize a normal lighting operation. That is, if the emergency lighting state has been entered prior to this, the power supply line is switched. If electric energy input to the charging management apparatus 10 is continuously detected, only a current power supply line is required to be maintained.

In one embodiment, when the charging management apparatus has electric energy input, the method further includes: receiving an external dimming signal inputted by a user, and regulating the power of the load lighting equipment based on the external dimming signal.

Specifically, in the embodiment, the emergency lighting circuit is also connected to a dimming apparatus during the normal lighting operation, and the user may input a dimming signal through the dimming apparatus, so as to realize a power regulation operation of the load lighting equipment in a normal lighting state, so that the load lighting equipment can be illuminated with brightness required by the user, which can effectively improve operational convenience of the emergency lighting circuit.

It should be noted that, in the solution of the present embodiment, the emergency lighting circuit further includes a dimming switching apparatus, the emergency control apparatus 50 is connected to the load lighting equipment through the dimming switching apparatus, and the dimming switching apparatus is connected to an external dimming apparatus. Through the dimming switching apparatus, an external dimming operation may be cut off in an emergency lighting state, an external dimming function is switched on in the normal lighting state, and the load lighting equipment can be regulated to required power to operate based on the dimming signal inputted by the user through the external dimming apparatus.

Referring to FIG. 4, in one embodiment, step S100 includes step S110 and step S120.

In step S110, an input-terminal voltage signal and an input-terminal current signal of the boost inverter of the emergency lighting circuit are collected in real time. In step S120, the input-terminal power signal is obtained based on the input-terminal voltage signal and the input-terminal current signal.

Specifically, the power detection apparatus 40 acquires the input-terminal power signal of the boost inverter 30 not in a unique manner. In the embodiment, the emergency battery apparatus 20 includes a battery and a sampling resistor, a first terminal of the battery is connected to the charging management apparatus 10 and the boost inverter 30, a second terminal of the battery is connected to a first terminal of the sampling resistor, the charging management apparatus 10 and the power detection apparatus 40, and a second terminal of the sampling resistor is connected to the boost inverter 30. Therefore, when the input-terminal power signal of the boost inverter 30 is acquired, only a voltage and a current are sampled through the sampling resistor to obtain the input-terminal voltage signal and the input-terminal current signal of the boost inverter 30, and then the input-terminal power signal of the boost inverter 30 can be directly calculated.

It may be understood that, in other embodiments, the input-terminal power signal of the boost inverter 30 may also be obtained in other manners. For example, the input-terminal power signal is obtained directly through a transformer, a power sampling chip or the like.

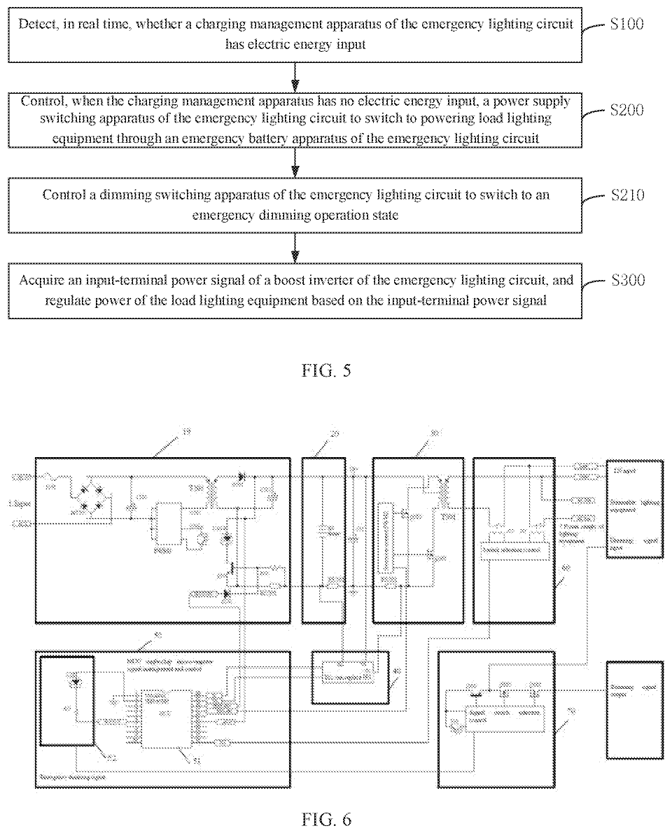

Referring to FIG. 5, in one embodiment, subsequent to step S200 and prior to step S300, the method further includes step S210.

In step S210, a dimming switching apparatus of the emergency lighting circuit is controlled to switch to an emergency dimming operation state.

Specifically, as shown above, the emergency lighting circuit further includes a dimming switching apparatus, the emergency control apparatus 50 is connected to the load lighting equipment through the dimming switching apparatus, and the dimming switching apparatus is connected to an external dimming apparatus. Therefore, in the embodiment, after the emergency lighting circuit is controlled to enter the emergency lighting state, the dimming switching apparatus is further required to be switched before the operating power of the load lighting equipment is regulated based on the input-terminal power signal of the boost inverter 30. Thus, the power of the load lighting equipment can be automatically regulated through the emergency control apparatus 50.

Further, in one embodiment, the operation of controlling a dimming switching apparatus of the emergency lighting circuit to switch to an emergency dimming operation state further includes disconnecting the external dimming apparatus from the load lighting equipment. That is, in the embodiment, in the emergency lighting state, the power of the load lighting equipment can be regulated only through the emergency control apparatus 50, and the user cannot regulate it according to his/her own need, thereby ensuring operation stability of the emergency lighting state. It may be understood that, in another embodiment, the external dimming apparatus may not be disconnected from the load lighting equipment, so that the power can be regulated correspondingly according to a user need even if in the emergency lighting state.

It should be noted that, a specific type of the dimming switching apparatus is not unique. In one embodiment, similar to the power supply switching apparatus 60, the dimming switching apparatus may also be a switch apparatus. When a dimming manner is switched, the emergency control apparatus 50 is required only to control a switch device corresponding to a dimming channel to be turned on. A specific type of the switch device is not unique, which may be a triode, a relay, or the like, provided that a switch function can be realized under the control of the emergency control apparatus 50.

According to the control method for an emergency lighting circuit, normal lighting is monitored by detecting whether the charging management apparatus 10 in the emergency lighting circuit has electric energy input, and when the charging management apparatus 10 has no electric energy input, it indicates failure of power supply of the external power source. In this case, emergency lighting may be started, and a power source transmitted to the load lighting equipment is switched to the emergency battery apparatus 20 through the power supply switching apparatus 60, which is processed by the boost inverter 30 to provide appropriate electric energy for the load lighting equipment. At the same time, the power detection apparatus 40 detects an input-terminal power signal of the boost inverter 30, and regulates power of the load lighting equipment based on the input-terminal power signal, to realize an emergency lighting operation. In the above solution, operating power of the load lighting equipment is regulated based on the input-terminal power signal of the boost inverter 30. An input-terminal voltage of the boost inverter 30 is a DC low voltage and easy to detect. Moreover, in the solution, high voltage and current are not required to be isolated for power detection, which effectively reduces detection costs and is highly reliable in power detection.

Referring to FIG. 2, an emergency lighting circuit includes a charging management apparatus 10, an emergency battery apparatus 20, a boost inverter 30, a power detection apparatus 40, a power supply switching apparatus 60 and an emergency control apparatus 50. The charging management apparatus 10 is connected to an external power source. The emergency battery apparatus 20 and the emergency control apparatus 50 are connected to the charging management apparatus 10. The emergency battery apparatus 20 is connected to an input terminal of the boost inverter 30 and the power detection apparatus 40. The power detection apparatus 40 is connected to the emergency control apparatus 50. A control terminal of the boost inverter 30 is connected to the emergency control apparatus 50. An output terminal of the boost inverter 30 is connected to the power supply switching apparatus 60. The power supply switching apparatus 60 is connected to the external power source. The emergency control apparatus 50 is connected to the power supply switching apparatus 60. The power supply switching apparatus 60 is connected to load lighting equipment. The emergency control apparatus 50 is connected to the load lighting equipment. The emergency control apparatus 50 is configured to perform emergency lighting control according to the control method described above.

Specifically, the charging management apparatus 10 is an apparatus that uses an external power source to charge and manage an energy storage device. In the solution of the present embodiment, the emergency lighting circuit is provided with the emergency control apparatus 50. The emergency control apparatus 50 is connected to the charging management apparatus 10, and can collect, in real time, an AC voltage signal inputted to the charging management apparatus 10 or a DC voltage signal into which the AC voltage signal is converted by the charging management apparatus 10, so as to detect whether an external AC power source is normally connected to supply power to the load lighting equipment.

It should be noted that, a specific structure of the charging management apparatus 10 is not unique, provided that it has an AC-DC conversion function as well as current-limiting charging and voltage-limiting charging functions for the energy storage device. For example, in a more detailed embodiment, referring to FIG. 6, the charging management apparatus 10 is connected to the external AC power source, and a fuse is provided at a junction with a live wire of the external AC power source. Then, a rectifier device is connected behind the fuse for AC/DC conversion. Finally, voltage limiting and current limiting charging for a back-end emergency battery apparatus 50 are realized by performing operations such as voltage transformation and current limiting on a DC power source outputted by the rectifier device.

The charging management apparatus 10 having no electric energy input may mean that an input terminal of the charging management apparatus has no AC power input 10 or a DC output terminal of the charging management apparatus 10 has no DC output. In either case, the external power source connected to the charging management apparatus 10 fails. The external power source is further configured to supply power to the load lighting equipment. When it is detected that the charging management apparatus 10 has no electric energy input, it indicates that the external power source cannot normally supply power to the load lighting equipment. In this case, the emergency control apparatus 50 may switch a power supply line through the power supply switching apparatus 60, which switches a line originally powering the load lighting equipment directly from the external power source to powering the load lighting equipment through electric energy stored in the emergency battery apparatus 20.

It should be noted that a specific type of the power supply switching apparatus 60 is not unique. In one embodiment, referring to FIG. 6, the power supply switching apparatus 60 is specifically a switch apparatus. In case of power supply switching, the power supply line can be switched only when the emergency control apparatus 50 controls a switch device corresponding to the emergency battery apparatus 20 to be turned on or controls a switch device corresponding to the external power source to be turned on. A specific type of the switch device is not unique, which may be a triode, a relay, or the like, provided that a switch function can be realized under the control of the emergency control apparatus 50.

After the emergency lighting state is entered, the electric energy stored in the emergency charging apparatus may be released, and originally stored low-voltage DC electricity is converted into electric energy with a higher voltage through boost and inversion functions of the boost inverter 30, so as to realize an operation of powering the load lighting equipment. At the same time, a power detection apparatus 40 is further arranged between the input terminal of the boost inverter 30 and output of the emergency battery apparatus 20. When emergency lighting is started, the power apparatus can detect an input-terminal power signal at the input terminal of the boost inverter 30 in real time, and then output a corresponding dimming signal to the load lighting equipment in combination with the input-terminal power signal, so as to regulate the load lighting equipment to corresponding power for operation.

Similarly, a specific structure of the boost inverter 30 is not unique. In one embodiment, referring to FIG. 6, the boost inverter 30 may include two parts, i.e., an inverter and a boost transformer. The inverter is connected to the emergency battery apparatus 20. The boost transformer is connected to the inverter and the power supply switching apparatus 60. Therefore, after DC electricity outputted by the corresponding emergency battery apparatus 20 is inverted and boosted, high-voltage electric energy is provided for the load lighting equipment.

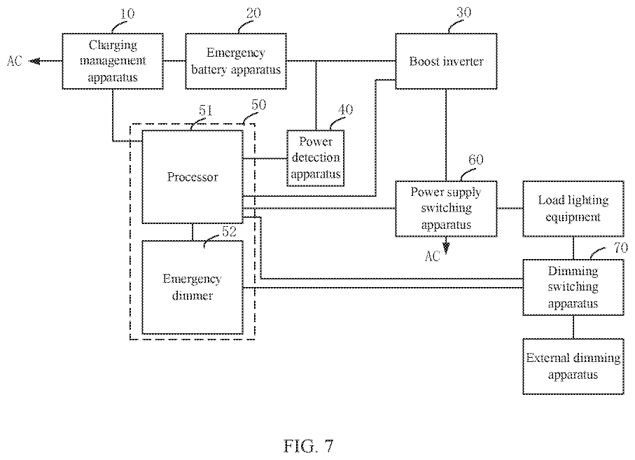

Referring to FIG. 7, in one embodiment, the emergency lighting circuit further includes a dimming switching apparatus 70, the emergency control apparatus 50 is connected to the load lighting equipment through the dimming switching apparatus 70, and the dimming switching apparatus 70 is connected to an external dimming apparatus.

Specifically, in the solution of the present embodiment, the emergency lighting circuit further includes a dimming switching apparatus 70, the emergency control apparatus 50 is connected to the load lighting equipment through the dimming switching apparatus 70, and the dimming switching apparatus 70 is connected to an external dimming apparatus. Through the dimming switching apparatus 70, an external dimming operation may be cut off in an emergency lighting state, an external dimming function is switched on in the normal lighting state, and the load lighting equipment can be regulated to required power to operate based on the dimming signal inputted by the user through the external dimming apparatus.

Referring to FIG. 7, in one embodiment, the emergency control apparatus 50 includes an emergency dimmer 52 and a processor 51 (which may specifically be a single-chip microcomputer or a microcontroller unit). The processor 51 is connected to the emergency dimmer 52. The emergency dimmer 52 and the processor 51 are connected to the dimming switching apparatus 70. The charging management apparatus 10, the power supply switching apparatus 60 and the input terminal and the control terminal of the boost inverter 30 are connected to the processor 51.

Specifically, the emergency lighting circuit further includes a dimming switching apparatus 70, the emergency dimmer 52 of the emergency control apparatus 50 is connected to the load lighting equipment through the dimming switching apparatus 70, and the dimming switching apparatus 70 is connected to an external dimming apparatus. Therefore, in the embodiment, after the emergency lighting circuit is controlled to enter the emergency lighting state, the processor 51 may also switch the dimming switching apparatus 70 before the operating power of the load lighting equipment is regulated based on the input-terminal power signal of the boost inverter 30, so that the emergency dimmer 52 is connected to the load lighting equipment through the dimming switching apparatus 70, and the power of the load lighting equipment is automatically regulated through the emergency dimmer 52.

It may be understood that, in one embodiment, the processor 51 can also control the dimming switching apparatus 70 to realize dimming switching while the emergency dimmer 52 automatically regulates the power of the load lighting equipment. In one embodiment, the dimming switching operation of the dimming switching apparatus 70 may be realized by the emergency dimmer 52 and the processor 51 in parallel or realized only by one of the emergency dimmer 52 and the processor 51.

Further, in one embodiment, the operation of controlling a dimming switching apparatus 70 of the emergency lighting circuit to switch to an emergency dimming operation state further includes disconnecting the external dimming apparatus from the load lighting equipment. That is, in the embodiment, in the emergency lighting state, the power of the load lighting equipment can be regulated only through the emergency control apparatus 50, and the user cannot regulate it according to his/her own need, thereby ensuring operation stability of the emergency lighting state. It may be understood that, in another embodiment, the external dimming apparatus may not be disconnected from the load lighting equipment, so that the power can be regulated correspondingly according to a user need even if in the emergency lighting state.

It should be noted that, a specific type of the dimming switching apparatus 70 is not unique. Referring to FIG. 6, in one embodiment, similar to the power supply switching apparatus 60, the dimming switching apparatus 70 may also be a switch apparatus. When a dimming manner is switched, the emergency control apparatus 50 is required only to control a switch device corresponding to a dimming channel to be turned on. A specific type of the switch device is not unique, which may be a triode, a relay, or the like, provided that a switch function can be realized under the control of the emergency control apparatus 50.

Referring to FIG. 6, in one embodiment, the emergency battery apparatus 20 includes a battery and a sampling resistor, a first terminal of the battery is connected to the charging management apparatus 10 and the boost inverter 30, a second terminal of the battery is connected to a first terminal of the sampling resistor, the charging management apparatus 10 and the power detection apparatus 40, and a second terminal of the sampling resistor is connected to the boost inverter 30.

Specifically, in the solution of the present embodiment, when the input-terminal power signal of the boost inverter 30 is acquired, only a voltage and a current are sampled through the sampling resistor to obtain the input-terminal voltage signal and the input-terminal current signal of the boost inverter 30, and then the input-terminal power signal of the boost inverter 30 can be directly calculated.

It may be understood that, in other embodiments, the input-terminal power signal of the boost inverter 30 may also be obtained in other manners. For example, the input-terminal power signal is obtained directly through a transformer, a power sampling chip or the like.

According to the above emergency lighting circuit, normal lighting is monitored by detecting whether the charging management apparatus 10 in the emergency lighting circuit has electric energy input, and when the charging management apparatus 10 has no electric energy input, it indicates failure of power supply of the external power source. In this case, emergency lighting may be started, and a power source transmitted to the load lighting equipment is switched to the emergency battery apparatus 20 through the power supply switching apparatus 60, which is processed by the boost inverter 30 to provide appropriate electric energy for the load lighting equipment. At the same time, the power detection apparatus 40 detects an input-terminal power signal of the boost inverter 30, and regulates power of the load lighting equipment based on the input-terminal power signal, to realize an emergency lighting operation. In the above solution, operating power of the load lighting equipment is regulated based on the input-terminal power signal of the boost inverter 30. An input-terminal voltage of the boost inverter 30 is a DC low voltage and easy to detect. Moreover, in the solution, high voltage and current are not required to be isolated for power detection, which effectively reduces detection costs and is highly reliable in power detection.

An emergency lighting system includes load lighting equipment and the emergency lighting circuit described above. The emergency control apparatus 50 is configured to perform emergency lighting control according to the control method described above.

Specifically, the emergency lighting circuit is as illustrated by the above embodiments and the drawings, and the charging management apparatus 10 is an apparatus that uses an external power source to charge and manage an energy storage device. In the solution of the present embodiment, the emergency lighting circuit is provided with the emergency control apparatus 50. The emergency control apparatus 50 is connected to the charging management apparatus 10, and can collect, in real time, an AC voltage signal inputted to the charging management apparatus 10 or a DC voltage signal into which the AC voltage signal is converted by the charging management apparatus 10, so as to detect whether an external AC power source is normally connected to supply power to the load lighting equipment.

The charging management apparatus 10 having no electric energy input may mean that an input terminal of the charging management apparatus has no AC power input 10 or a DC output terminal of the charging management apparatus 10 has no DC output. In either case, the external power source connected to the charging management apparatus 10 fails. The external power source is further configured to supply power to the load lighting equipment. When it is detected that the charging management apparatus 10 has no electric energy input, it indicates that the external power source cannot normally supply power to the load lighting equipment. In this case, the emergency control apparatus 50 may switch a power supply line through the power supply switching apparatus 60, which switches a line originally powering the load lighting equipment directly from the external power source to powering the load lighting equipment through electric energy stored in the emergency battery apparatus 20.

After the emergency lighting state is entered, the electric energy stored in the emergency charging apparatus may be released, and originally stored low-voltage DC electricity is converted into electric energy with a higher voltage through boost and inversion functions of the boost inverter 30, so as to realize an operation of powering the load lighting equipment. At the same time, a power detection apparatus 40 is further arranged between the input terminal of the boost inverter 30 and output of the emergency battery apparatus 20. When emergency lighting is started, the power apparatus can detect an input-terminal power signal at the input terminal of the boost inverter 30 in real time, and then output a corresponding dimming signal to the load lighting equipment in combination with the input-terminal power signal, so as to regulate the load lighting equipment to corresponding power for operation.

According to the above emergency lighting system, normal lighting is monitored by detecting whether the charging management apparatus 10 in the emergency lighting circuit has electric energy input, and when the charging management apparatus 10 has no electric energy input, it indicates failure of power supply of the external power source. In this case, emergency lighting may be started, and a power source transmitted to the load lighting equipment is switched to the emergency battery apparatus 20 through the power supply switching apparatus 60, which is processed by the boost inverter 30 to provide appropriate electric energy for the load lighting equipment. At the same time, the power detection apparatus 40 detects an input-terminal power signal of the boost inverter 30, and regulates power of the load lighting equipment based on the input-terminal power signal, to realize an emergency lighting operation. In the above solution, operating power of the load lighting equipment is regulated based on the input-terminal power signal of the boost inverter 30. An input-terminal voltage of the boost inverter 30 is a DC low voltage and easy to detect. Moreover, in the solution, high voltage and current are not required to be isolated for power detection, which effectively reduces detection costs and is highly reliable in power detection.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A control method for an emergency lighting circuit, comprising:
detecting, in real time, whether a charging management apparatus of the emergency lighting circuit has electric energy input;
controlling, when the charging management apparatus has no electric energy input, a power supply switching apparatus of the emergency lighting circuit to switch to powering load lighting equipment through an emergency battery apparatus of the emergency lighting circuit;
acquiring an input-terminal power signal of a boost inverter of the emergency lighting circuit, and regulating power of the load lighting equipment based on the input-terminal power signal; the input-terminal power signal being detected and sent through a power detection apparatus of the emergency lighting circuit, the charging management apparatus and the power supply switching apparatus being connected to an external power source, the charging management apparatus being connected to the emergency battery apparatus, the emergency battery apparatus being connected to an input terminal of the boost inverter and the power detection apparatus, an output terminal of the boost inverter being connected to the power supply switching apparatus, and the power supply switching apparatus being connected to the load lighting equipment.

2. The control method according to claim 1, further comprising: subsequent to the step of detecting, in real time, whether a charging management apparatus of the emergency lighting circuit has electric energy input,
controlling, when the charging management apparatus has electric energy input, the power supply switching apparatus of the emergency lighting circuit to switch to powering the load lighting equipment through the external power source.

3. The control method according to claim 2, further comprising: when the charging management apparatus has electric energy input, receiving an external dimming signal inputted by a user, and regulating the power of the load lighting equipment based on the external dimming signal.

4. The control method according to claim 1, wherein the step of acquiring an input-terminal power signal of a boost inverter of the emergency lighting circuit comprises:
collecting an input-terminal voltage signal and an input-terminal current signal of the boost inverter of the emergency lighting circuit in real time;
obtaining the input-terminal power signal based on the input-terminal voltage signal and the input-terminal current signal.

5. The control method according to claim 1, further comprising: subsequent to the step of controlling, when the charging management apparatus has no electric energy input, a power supply switching apparatus of the emergency lighting circuit to switch to powering load lighting equipment through an emergency battery apparatus of the emergency lighting circuit and prior to the step of acquiring an input-terminal power signal of a boost inverter of the emergency lighting circuit, and regulating power of the load lighting equipment based on the input-terminal power signal,
controlling a dimming switching apparatus of the emergency lighting circuit to switch to an emergency dimming operation state.

6. An emergency lighting circuit, comprising: a charging management apparatus, an emergency battery apparatus, a boost inverter, a power detection apparatus, a power supply switching apparatus and an emergency control apparatus,
the charging management apparatus being connected to an external power source, the emergency battery apparatus and the emergency control apparatus being connected to the charging management apparatus, the emergency battery apparatus being connected to an input terminal of the boost inverter and the power detection apparatus, the power detection apparatus being connected to the emergency control apparatus, a control terminal of the boost inverter being connected to the emergency control apparatus, an output terminal of the boost inverter being connected to the power supply switching apparatus, the power supply switching apparatus being connected to the external power source, the emergency control apparatus being connected to the power supply switching apparatus, the power supply switching apparatus being connected to load lighting equipment, and the emergency control apparatus being connected to the load lighting equipment; the emergency control apparatus being configured to perform emergency lighting control with the control method according to claim 1.

7. The emergency lighting circuit according to claim 6, wherein the emergency lighting circuit further comprises a dimming switching apparatus, the emergency control apparatus is connected to the load lighting equipment through the dimming switching apparatus, and the dimming switching apparatus is connected to an external dimming apparatus.

8. The emergency lighting circuit according to claim 7, wherein the emergency control apparatus comprises an emergency dimmer and a processor, the processor is connected to the emergency dimmer, the emergency dimmer and the processor are connected to the dimming switching apparatus, and the charging management apparatus, the power supply switching apparatus and the input terminal and the control terminal of the boost inverter are connected to the processor.

9. The emergency lighting circuit according to claim 6, wherein the emergency battery apparatus comprises a battery and a sampling resistor, a first terminal of the battery is connected to the charging management apparatus and the boost inverter, a second terminal of the battery is connected to a first terminal of the sampling resistor, the charging management apparatus and the power detection apparatus, and a second terminal of the sampling resistor is connected to the boost inverter.

10. An emergency lighting system, comprising load lighting equipment and an emergency lighting circuit, the emergency lighting circuit comprising: a charging management apparatus, an emergency battery apparatus, a boost inverter, a power detection apparatus, a power supply switching apparatus and an emergency control apparatus,
the charging management apparatus being connected to an external power source, the emergency battery apparatus and the emergency control apparatus being connected to the charging management apparatus, the emergency battery apparatus being connected to an input terminal of the boost inverter and the power detection apparatus, the power detection apparatus being connected to the emergency control apparatus, a control terminal of the boost inverter being connected to the emergency control apparatus, an output terminal of the boost inverter being connected to the power supply switching apparatus, the power supply switching apparatus being connected to the external power source, the emergency control apparatus being connected to the power supply switching apparatus, the power supply switching apparatus being connected to load lighting equipment, and the emergency control apparatus being connected to the load lighting equipment; the emergency control apparatus being configured to perform emergency lighting control with the control method according to claim 1.
